(19) United States
(12) Patent Application Publication
(10) Pub. No.: US 2026/0078555 A1
(43) Pub. Date: Mar. 19, 2026

(54) SYSTEMS AND UNITS FOR MARINE INFRASTRUCTURE FOUNDATION SCOUR PROTECTION

(71) Applicant: ECONCRETE TECH LTD, Tel Aviv (IL)

(72) Inventor: IDO SELLA, TEL AVIV (IL)

(73) Assignee: ECONCRETE TECH LTD, Tel Aviv (IL)

(21) Appl. No.: 19/107,095

(22) PCT Filed: Aug. 28, 2023
(86) PCT No.: PCT/IL2023/050913

§ 371 Date: Feb. 27, 2025

Related U.S. Application Data
(60) Provisional application No. 63/401,667, filed on Aug. 28, 2022.

(51) Int. Cl. E02B 17/00; C04B 7/02; C04B 111/00; E02B 3/04; E02B 3/12

(52) U.S. Cl. CPC E02B 17/0017; C04B 7/02; E02B 3/046; E02B 3/129; C04B 2111/00017

(57) ABSTRACT

The invention provides scour protection methods and systems comprising a plurality of units, wherein each unit comprises a concrete matrix having a pH of less than 12; and wherein each unit can interlock with another unit: wherein said systems promotes and enhances the marine biological fauna and flora at the proximity of offshore aquatic infrastructures.

### BACKGROUND OF THE INVENTION

The intensified development of urban foreshores, coastlines, and offshore areas is driving a phenomenon known as “ocean sprawl,” the removal or transformation of natural habitats through the addition of complex artificial infrastructure in the marine environment (e.g., energy, aquaculture, coastal defences). Due to the lack of available structurally sound ecologically engineered alternatives, coastal and marine infrastructure (CMI) is designed and built with little or no ecological consideration, leading to a high environmental footprint. More than 50% of CMIs are made with standard “grey” concrete, which is a poor substrate for biological recruitment due to the adverse surface chemistry that impairs the settlement of various marine larvae. Subsequently, communities developing on CMI are typically less diverse than natural assemblages and are commonly dominated by nuisance and invasive species.

The offshore wind industry is a rapidly growing source of energy globally, alongside traditional oil, gas. Once making up only 1% of global wind energy installations in 2009, offshore now represents 10% of the global wind energy industry. The total global offshore wind market had grown on average by 24% since 2013. Europe has been the traditional market for offshore wind developments, making up 75% of global wind installations. However, in recent years China has become a major player in offshore wind, installing 2.4 gigawatts (GW) worth of offshore wind energy in 2019 alone (global total installations in 2019 reached 6.1 GW).

In developing offshore energy and civil installations, foundations are required to anchor erected infrastructures such as wind turbines and oil/gas rigs to the seafloor, as well as stabilize cables, pipes, and other kinds of civil infrastructure. Depending on ocean surface conditions, sea-level depth, geological factors, and other environmental considerations, different foundations are used. Foundations for offshore infrastructure are subjected to forces from wind action on the wind turbines as well as on the substations and rigs, in addition to ocean forces below the surface. Several different types of offshore foundations are used, among them the three main classes include pile-based foundations, gravity/suction-based foundations, and floating structures anchors. Concrete is heavily used in the construction of offshore installations as structural components and/or protective mechanisms. Scouring is a key challenge to address in the offshore industry, as the abrasive nature of the ocean floor can lead to damage of offshore infrastructure.

Regulations differ between nations, but many governments impose similar conditions for developers in the construction and operation of offshore infrastructure. The IEA, International Energy Agency, has set general guidelines for over 30 member and association countries including the UK, Germany, USA, and China that outline environmental disruption, minimum installed capacity, distance from coastline and bid systems (IEA). Specific national and state/province policies are put in place in addition to the general guidelines, but many of these are based on government initiatives to increase renewable energy generation.

Environmental impact assessments indicate that the construction and operation of offshore infrastructures such as wind farms, substation rigs, power cables, oil and gas rigs, pipelines, and other forms of civil infrastructure can have both positive and negative impacts on the surrounding environment. The primary issues that arise include the negative impact of physical disturbances on the local habitat and the noise pollution above and below the water's surface.

There is a need to provide a system for scour protection that is both cost-effective, provides less exposure of the environment to harmful contaminants and promotes and enhances the marine biological fauna and flora at the proximity of offshore marine or aquatic infrastructures.

There is a need to develop a nature-inspired solution for thriving ecosystems on high-performing concrete structures., providing fully structural, bio-enhancing concrete solutions; designed to encourage the development of rich and diverse marine life as an integral part of CMI. There is a need to develop concrete based scour protection systems that improve the water quality around the CMI, increasing the concrete compressive strength, and lowering chloride penetration.

The system of the invention provides eco-scour protection units that leverages offshore infrastructure scour protection needs to create a hospitable habitat for the offshore ecosystem.

### SUMMARY OF THE INVENTION

The invention provides a system comprising a plurality of units, wherein each unit comprises a concrete matrix having a pH of less than 12; and wherein at least one unit of said plurality of units can interlock with at least one other unit of said plurality of units; and wherein said system is a scour protection system for an aquatic infrastructure.

In some embodiments, the average weight of said unit of said plurality of units is between about 20-150 kg.

In some embodiments, the average weight of said unit of said plurality of units is at least about 50 kg.

In some embodiments, the average weight of said plurality of units is between about 2,000-100,000,000 kg.

In some embodiments, the average weight of said plurality of units is at least about 2,000 kg.

When referring to a “plurality of units” it should be understood that the system of the invention comprises at least 300 units, wherein each unit has the same or different three-dimensional construct comprising and formed from a concrete matrix having a pH of less than 12.

Furthermore, each unit of said plurality of units can interlock with at least one other unit said plurality of units. When referring to “interlocking” of units it should be understood to relate to any type of connection (either one unit on top of at least one other unit of said plurality of units, one unit below the at least one other unit of said plurality of units, one unit locked on at least one other unit of said plurality of units, one unit connected/interconnected to at least one other unit said plurality of units, one unit linked to at least one other unit of said plurality of units, and so forth) between at least two units of the system of the invention so that the motion, displacement, movement, shifting, dislodgment, dislocation or operation of each unit is constrained, inhibited, hindered, halted by said at least one other unit of said plurality of units.

It should be understood that such interlocking of said units of said the plurality of units of the system of the invention is achieved when the system is being diploid (by means of releasing said plurality of units into the aquatic environment at the preferred site) as a scour protection system for aquatic infrastructure. FIGS. 1 to 8 provide exemplary embodiments of units used by the system of the invention which allow interlocking.

When referring to a “scour protection system for marine and aquatic infrastructure” it should be understood to encompass a system that prevents loss of seabed sediment around any aquatic infrastructure placed in or on the aquatic bed (seabed, ocean floor and so forth). The system when said multiple units are deployed (placed) forms a protective apron, mattress, or any other structure around the base of said aquatic infrastructure with or without frond devices, or rock and gravel placement. The system of the invention is a scour protection system for an aquatic infrastructure or environment when said plurality of units of the system are placed (either randomly, orderly, specifically, densely compactly, neatly and so forth) in or on said aquatic floor around said aquatic infrastructure protecting loss of sediment around any aquatic infrastructure.

The term “marine or aquatic construction infrastructure” should be understood to encompass any type, shape or size of an infrastructure that is defined to be suitable for marine or aquatic construction including coastal defense structures such as breakwaters, seawalls, revetments and groins, bulkheads, piers, berths, and related infrastructures as well as out of coastal waters infrastructure such as ones in commercial waters and international waters. Examples of such marine construction infrastructure includes, piles, bridge bases, seaward berms, rigs and wind turbine foundations, under water cables protection and pipes casing, mooring units, and others.

The term “concrete matrix” refers to a concrete composition typically comprising at least one type of cement (such as for example Portland cement or Calcium aluminate cements), at least one aggregate (such as for example lime stone, blue stone), sand (fine graded aggregate less 4.75 mm and or natural or crashed aggregate less 0-2 mm) and water (potable, and shall not contain more than 1000 parts per million of chlorides or sulfates, free from harmful substances such as lead, copper, zinc (<5 ppm) or phosphates (<5 ppm)).

When referring to “aquatic environment” it should be understood to encompass any type of body of water including, but not limited to marine (including oceanic zones, benthic zones, intertidal zones, neritic zones, estuaries, salt marshes, coral reefs, lagoons and mangrove swamps) and freshwater (including lentic, lotic, wetlands and ponds). The term relates to any depth of said aquatic environment, at any temperature, at any time of year or condition of weather and any flow rates.

When referring to “fauna and flora” it should be understood to encompass any type of plant, organism or animal that is typical to the aquatic environmental ecosystem involved.

In some embodiments marine or aquatic fauna and flora includes at least one of the following: (i) engineering species such as corals, oysters, serpulid worms, coralline algae and barnacles, that deposit a calcitic skeleton which elevates the structural complexity of the structure and create habitat for other organisms; (ii) filter feeding organisms such as oysters, mussels, tunicates and sponges that feed using filtering organs while in the process uptake nutrients and organic particles from the water; (iii) endolithic/epilithic blue-green algae, and in certain cases when concrete surface is above water level also lichens, fungi and mosses.

When referring to “promotion of fauna and flora growth” it should be understood to encompass any qualitative or quantitative promotion, enhancement, reinforcement, fortification, strengthening, support, recruitment or support of the stability, growth, health and proliferation of fauna and flora either already growing or is capable of growing in aquatic environmental ecosystem, measurable by any parameter known in the art (number of individuals or species, life cycle, coverage of growth or a surface, etc.).

In some embodiments said promotion of marine fauna and flora facilitates deposition of inorganic matter on the surface of said structure can reach values between about 50 to 1000 gr/m² after 12 months at a depth range of 1-10 meters. While chlorophyll concentration on the surface of said structure can reach values between about 100 to 800 μgr/m after 12 months at a depth range of 1-10 meters.

In other embodiments said promotion of marine fauna and flora provides coral recruits on the surface of said structure is between about 5 to 25 recruits per 15×15 surface area after 12 months at a depth range of 1-10 meters, and coral settlement rates under laboratory conditions on the surface of said structure is between about 5 to 60% after <1 month.

In a further aspect the invention provides a method of promoting the growth of endolitic and epilitic flora comprising providing a system for score protection of aquatic infrastructure composed of a concrete matrix having a surface pH of less than 12. It is to be noted that such infrastructure may also be terMediterranean bioactive terrestrial structure (i.e. bioactive structure above the water level, however with sufficient humidity and precipitates to promote the growth of terrestrial flora as in natural systems.

The term “endolitic and epilitic flora” should be understood to encompass lichens, fungi, mosses, as well as blue-green algae. It is to be noted that such endolitic and epilitic flora can be grown in land environments—with sufficient humidity and precipitates. In some embodiments, such infrastructure mentioned herein above is a “bioactive wall” element that is designed to induce rapid plant wall coverage of inland buildings. Green plant coverage significantly improves urban landscape, provides cleaner and healthier air, and reduces the ecological footprint of urban development. The physical and chemical properties of the wall substrates strongly influence its capability to support and enhance growth. In some embodiments such bioactive wall structure induces natural growth of wall clinging plants, endolithic algae, lichens and mosses. In some further embodiments said bioactive wall structure has high complexity and porosity that allows creating moist niches that support flora, without the need for complex soil systems.

In another one of its aspect the invention provides a method of promoting the growth of endolitic and epilitic anaerobic and aerobic flora and fauna comprising providing a score protection system for aquatic infrastructure composed of a concrete matrix having a pH of less than 12.

In a further aspect the invention provides a method of scour protecting an aquatic infrastructure comprising providing a system comprising a plurality of units, wherein each unit comprises a concrete matrix having a pH of less than 12; and wherein each unit can interlock with at least one other unit of said plurality of units.

In some embodiments, an aquatic infrastructure relates to a marine infrastructure. In some embodiments, an aquatic infrastructure relates to an offshore aquatic infrastructure. In some embodiments, an aquatic infrastructure relates to a freshwater infrastructure.

In some embodiments, said scour protection system of the invention has a porosity of at least 30%. In other embodiments, said scour protection system of the invention has a porosity of at least 40%. In other embodiments, said scour protection system of the invention has a porosity of at least 50%. In other embodiments, said scour protection system of the invention has a porosity of between about 30% to about 60%.

Since a scour protection system of the invention comprises a plurality of units, it should be understood that when referring to “porosity” it relates to the ratio of the pore volume of said scour protection system (the pores that exist between the plurality of units of said system) to the total volume of said scour protection, defined as p=Vp/VT. The porosity parameter provides the relation between the amount of voids present in a given volume a quantity of bulk scour protection system (which comprises a plurality of units) occupies. The porosity value of a system comprising a plurality of units depends on its physical properties as well as the placement method. Among the most relevant physical properties of the a system comprising a plurality of units that affects its porosity are the shape, surface roughness, roundness, size and mass distribution (grading) of the system units. In order to make an accurate estimation, armor rock features have been standardized into normalized gradings compliant with EN 13383 which are the most widely used within the industry. Among the standard gradings, one that has been commonly used is the 60 to 300 kg. With regards to the placement method, a system comprising a plurality of units can be randomly placed, standardly placed, densely placed or specifically placed. In some embodiments, the placement of a system comprising a plurality of units is made in a random manner.

The advantages of a system of the present invention that comprises a plurality of units that are designed to interlock at least one unit of said plurality of units with at least one other unit as compared with known armor rock scour protection systems include: the ability of densifying and interlocking the scour protection capacity compared to random rock pile that is randomly placed on the seabed, this provides regular and constant unit shape and grading curves and additionally the layer packing together with the unit shape and the grading controls interlocking between units and hence shear strength of units within the scour protection pile and between layers of units.

It should be noted that the hydraulic stability of a scour protection system of the invention is comparable to the hydraulic stability of rock scour protection known in the art, as required using the parameters evaluating the hydraulic stability of rock structures (typically consisting of combinations of hydraulic parameters and material parameters, including wave and current attack, characterization of the armor units, cross-section of the system structure, response of the system structure and so forth).

In some embodiments, the said structure mentioned herein above is a “live rock” structure, i.e. a structure according to the invention placed in separated closed marine environments, such as for example aquarium (such as salt water aquarium). Such live rock structures confer to the closed marine environments multiple benefits desired by the saltwater aquarium hobbyist. A live rock structure of the invention provides superior biological filter that hosts both aerobic and anaerobic nitrifying bacteria required for the nitrogen cycle that processes waste. Thus, said live rock becomes the main biological nitrification base or biological filter of a saltwater or freshwater aquarium. Additionally, a live rock structure of the invention may also have a stabilizing effect on the water chemistry, in particular on helping to maintain constant pH by release of calcium carbonate. Further a live rock structure is a decorative element of the aquarium and provides shelter for the inhabitants.

It is to be noted that promoting the growth of endolitic and epilitic anaerobic and aerobic flora and fauna, such as for example Nitrobacter and nitrosomans.

In some embodiments said concrete matrix has a pH of less than about 11. In other embodiments said concrete matrix has a pH of between about 9 to about 10.5. In some embodiments, said pH of said concrete matrix is the pH of substantially the entire concrete infrastructure. In other embodiments said pH of said concrete matrix is the pH substantially the top surface of said infrastructure. In yet further embodiments the thickness of said top surface is about 5 cm or more.

In some embodiments the salinity of said aquatic environment is between about 0 to 45 ppt (i.e., salinity can be 0, 1, 2, 3, 4, 5, 10, 15, 20, 25, 30, 35, 40, 45 ppt).

Enhancement of flora and fauna relates to aquatic environments in areas exposed to sufficient light, i.e., within the photic zone (0-100 meters depth maximum) and in areas from the seabed and up to the splash zone, or above for Bioactive structures that support terrestrial flora.

In some embodiments, said at least one unit has a surface roughness having a roughness grade of at least 12. In other embodiments, said infrastructure has an RA value of at least 50 microns. In addition, said infrastructure has a surface texture with an RA value of at 5-20 mm.

In some other embodiments said concrete matrix has a weight per volume of between about 1100 to about 2500 Kg/m. In yet further embodiments said concrete matrix has a weight per volume of between about 1100 to about 1800 Kg/m.

In further embodiments said concrete matrix comprises with additives and cements in weight between 0 to about 90% of the Portland cement weight or completely replacing it.

In other embodiments said concrete matrix comprises at least one of micro-silica/silica fume and metakaolin and Calcium aluminate cements. In some embodiments above noted silica and/or metakaolin and/or calcium alumina cement is added to concrete matrix to replace any equivalent weight % amount of Portland cement in the matrix. In some further embodiments, concrete matrix has average compressive strength of between about 20 to 80 Mpa (i.e. about 20, 25, 30, 35, 40, 45, 50, 55, 60, 65, 70, 75 or 80 Mpa).

In some further embodiments said concrete matrix has water pressure penetration resistance of between about 5 to 50 mm under the pressure of 7 bar (i.e., about 5, 10, 15, 20, 25, 30, 35, 40, 45, 50 mm). (EN 12390-8)

In other embodiments said concrete matrix has chloride penetration resistance of between about 500 to 2000 Coulombs (i.e., about 500, 600, 700, 800, 900, 1000, 1100, 1200, 1300, 1400, 1500, 1600, 1700, 1800, 1900, 2000 Coulombs. (ASTM c 1202).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1-8 show structural embodiments (top, bottom and cross section views) of units of said plurality of units used by the system of the invention.

FIG. 9 shows the plurality of units of a system of the invention prior to manual deployment off a wooden funnel into water, to simulate the barge side drop mechanism.

FIGS. 10 and 11 show water deployed systems of the invention and the interlocking pattern achieved.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Boundary conditions such as hydrodynamic conditions, type of soils and location were taken in consideration, during the product design. This was primary focused on ensuring the external stability of the scour protection will be able to withstand waves and currents.

These are hydraulic/soils nature technical criteria for product identification: defined return period (e.g. 50 years), wind speed (m/s), current speed (m/s), significant wave height and peak period, bottom orbital velocity, predominant wave direction, predominant current direction, type of soils and depth impact on the scour protection that will be most effective.

The size of the product was derived from typical sizes of rock used for scour protection in reference Offshore projects and considering different parameters such as average depth, type of soils and internal friction angle, estimation of the length of the scour protection and estimated size of rocks at different locations with the different local boundary conditions.

From those investigations, in European Offshore Wind parks, with depths around >20 m a typical D50=0.45 m W50=276 kg (e.g. 200-400 kg grading) has been in use.

Additional relevant data extracted: The diameter of the pile depends on the foundation type; gravity foundations have a diameter between 10-17 m while monopiles diameter is between 4-6 m, D50 is between 0.42-0.55 m, Dn50: 0.35-0.46 m; W50: 113 kg-255 kg (ρrock: 2650 kg/m3), Layer thickness: >2D50 2Dn50=0.70-0.92 m; Layer thickness placed in the 5 examples: 1.20 m-1.80 m, Length of the scour protection. Several formulae proposed. One of the most used is the proposed by the DNV Std. (depends on the maximum scour depth, the internal friction coefficient and the diameter of the pile).

$${L}_{ext} = \frac{D}{2} + {S}_{max} \cdot cot ∅$$

On another hand, the weight of the rock armor units considered in the Empire Wind is 70 kg. In addition, the internal stability of the scour protection has to insure prevention of fine material migration through gaps and voids in the protective layers. Flexibility of the scour protection.

ECOncrete infrastructures are based on a series of concrete mixes and science-based designs which provide suitable biological and environmental conditions for the development of rich and diverse floral and faunal communities while lowering the ratio of invasive to native species. ECOncrete infrastructures promote marine organisms' settlement and restoration of local ecosystems by enhancing the ecological value of the constructed structure and mimicking the natural conditions.

The bio-enhancing concrete serve as means to add resilience to coastal and marine infrastructure by benefiting from the growth of the biological crust of ecosystem engineers, constantly growing and layering their skeletons on the infrastructure. The biogenic buildup, often calcitic crust that develops on eco engineered/bio-enhanced structures, serves both as a protective layer that can potentially reinforce the structure and promote the carbon storage value of the infrastructure. After appointing a specific location for installation, ECOncrete's biological team will survey the area in order to define local habitats and species present. Together with local authorities, the target species will be defined, and the suggested infrastructure will be designed in accordance with the target species' preferred habitat.

Due to the fact that the location is not specific, the hydrodynamics, waves, and currents and the soils nature are unknown, the designed unit will correspond with ˜20-70 kg in average rock size for scour protection (estimated concrete density: 2,400 kg/m3) to be placed on top of a filter layer (estimated 5-20 kg) that will be spread on the seabed and it will be extended 10 m all around the area occupied by the armor layer.

The hydraulic stability of the scour protection with ECOncrete armor units is intended to be achieved not only by the weight of the units, but also by the design. The units are designed to be cast with C35/80 Mpa-concrete to endure unloading from the factory to the working dock and then to a vessel, as well as deployment from the vessel to the seabed.

Marine infrastructure is constructed under strict building codes and standards and built for intensive use in a prolonged design life. Examples include ports, marinas, breakwaters, oil and gas platforms, wind turbines and alike. Any application of ecological enhancements to these facilities is required to comply with (1) local and international construction standards-ASTM international, European Standards (EN), The American Association of State Highway and Transportation Officials (AASHTO), etc.; (2) local construction methods and labor codes; (3) structure design life; and (4) economic justification. These rigorous restrictions often result in a traditional design and construction process, excluding the principles of nature inclusive design that could result in the infrastructure having limited ability to support marine flora and fauna native to the local ecosystems. Scour protection armor are applied to large scale projects across the globe in various climates and are designed to withstand the intense hydrodynamic forces exerted upon coastal or offshore infrastructure. The concrete units required to endure the forces applied by operational activities, ranging from stockpiling to marine and terrestrial vessel movement. In addition, the weight of a single block and their interlocking capacity play a crucial role in their structural integrity and functionality. As scour protections are applied in the extreme intertidal conditions (changing salinity and temperature, dry-wet cycles, hydrodynamic forces and freeze-thaw cycles), any addition of ecologically relevant features should go through extensive structural testing. In addition to verifying the design life, no compromise should be made in achieving performance results that meet or exceed that of the standard.

### Free Fall of Concrete Units of a System of the Invention in Water and Investigation on the Interlocking of the Units at the Bottom

Location: All the tests were performed in Israel. The first day of testing (preliminary design evaluation) was conducted in a 130 cm deep pool in Holon, Israel. The second day of testing (detailed design evaluation) was conducted in a 190 cm deep pool in Yafit, Israel.

Date and time: The design evaluation tests took place in July, 28th. Starting at 10.00 h local time; In depth performance evaluation tests took place in August, 16th. Starting at 7.30 h local time; Temperature: the temperature during both days oscillated between 30-35° C.; Weight sensitivity: the weight used to weigh the model units has a sensitivity of ±30 g; Water properties: fresh water with an estimated density of 1000 kg/m3.

Material specification and unit properties: The ECOncrete scour protection model units that were tested were produced with the following mix: 1 part sand, 0.6 parts cement, 0.3 parts water, 0.8 g plasticizer. Mix density: 2,400 kg/m3 Scale: 1:8.25

Production method: Wet casting into rubber molds Water properties: Fresh water with an estimated density of 1000 kg/m3.

The difference in density between seawater (1,030 kg/m3) and fresh water (1,000 kg/m3) was not included in the assessment. The density of the model units should have been 2,329 kg/m3 instead of 2,400 kg/m3 in order to get similar conditions between the relative density in prototype and relative density in the model. Therefore, the model units were heavier than they would be at the sea. A measuring tape was used to collect the spread radius data. All the tests were recorded with video cameras positioned strategically to follow the tests. In addition, pictures and videos of close areas of the units were taken after each drop. After each drop, the position and orientation of the units was recorded and categorized.

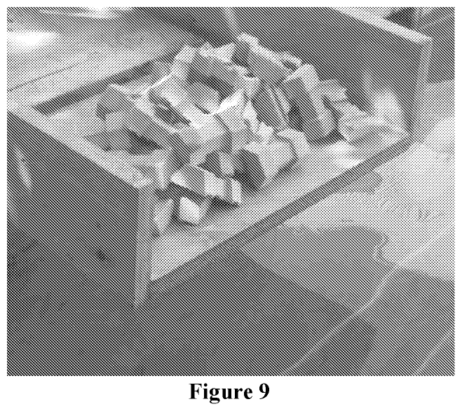

A rubber mat was adhered to a plastic sheet had been placed at the bottom of the pool to simulate surface texture. The units were slid manually off a wooden funnel into the water, to simulate the barge side drop mechanism (FIG. 9).

Preliminary geometrical design for design evaluation: The preliminary geometrical design of the units was based on the following criteria: perceived geometrical potential for qualifying the biological attributes, mass production and operational feasibility; structural robustness for clashing or hitting the bottom and/or hitting other units after the free fall in water and interlocking of at least two units of the system.

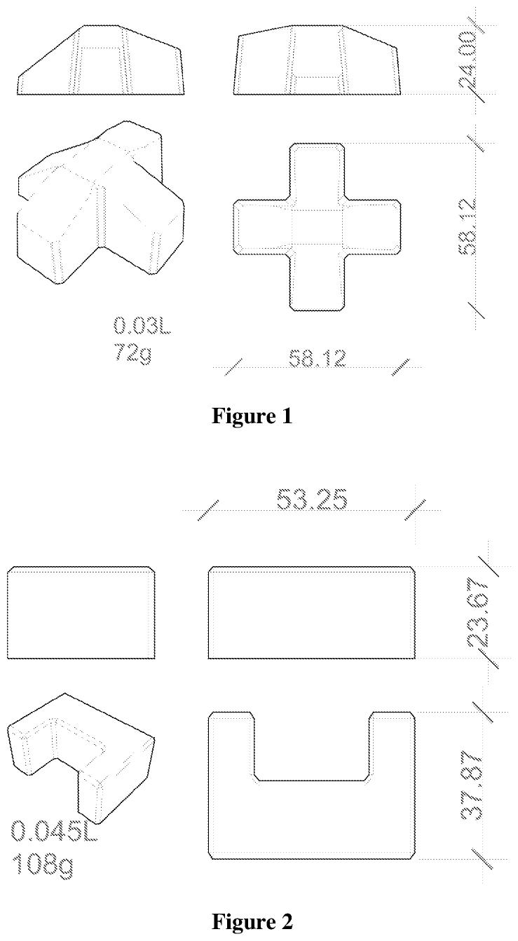

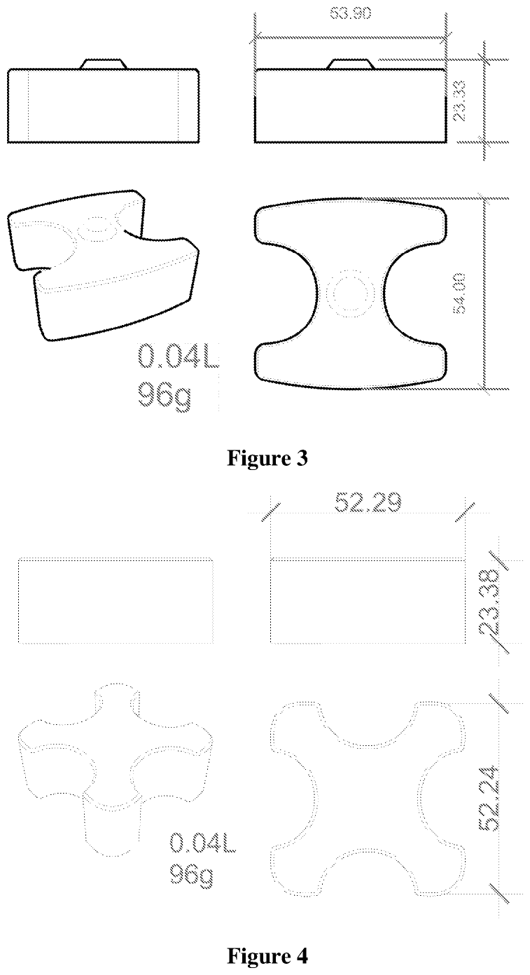

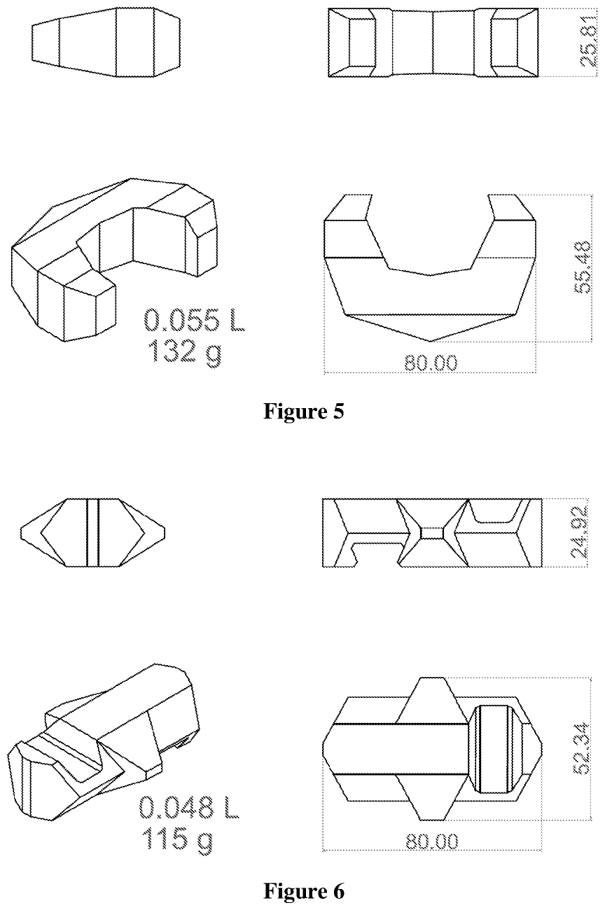

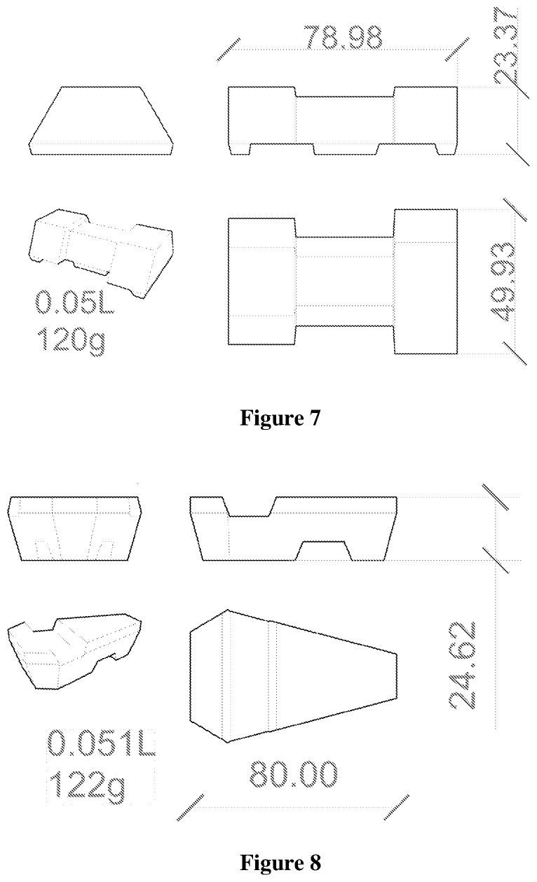

The designs of FIGS. 1 to 8 were developed and tested during the preliminary tests' evaluation stage. Measurements are in millimeters and referred to the scale models.

Single unit alignment test protocol: A single unit of each type was dropped in 3 different alignments to test their effect on the resulting alignment on the bottom of the pool. This procedure repeats 3 times for each design.

Group drop test protocol: A group of 40 units was pushed into the water from the funnel. The funnel's height above the water was 15 cm. The resulting spread of units was then measured on three variables: scatter diameter, height of accumulation, and interlocking abilities. This procedure was repeated three times for each design.

Test results: Units tend to orient towards a face which distributes the mass of the unit evenly, and if possible, has a more angular surface area than its parallel face, thus it has less drag. The drop orientation has little or no effect on the landing orientation. A unit with an eccentric center of gravity tends to sway and flip more than its counterparts.

Units with slots and sharp corners seem to interlock better. Multiple designs dropped together have no significant effect on the quality of the results.

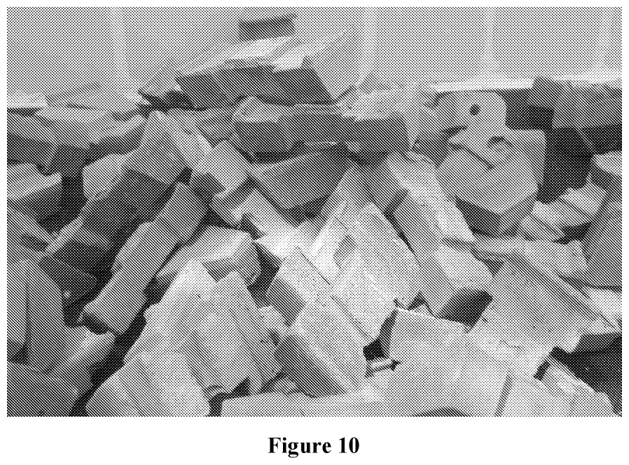

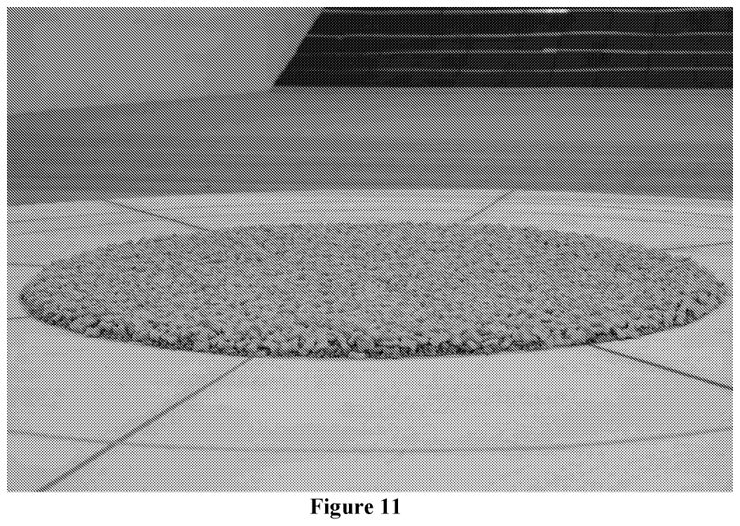

FIGS. 10 and 11 show the deployment of a system of the invention as score protection and the interlocking patterns of said units of the system of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true scope of the invention.

1. A system comprising a plurality of units, wherein each unit comprises a concrete matrix having a pH of less than 12; and wherein each unit can interlock with another unit; wherein said system is a scour protection system for an aquatic infrastructure.

2. A system according to claim 1, wherein the average weight of said unit is between about 20 kg to about 150 kg.

3. A system according to claim 1, wherein the average weight of said unit is at least about 50 kg.

4. A system according to claim 1, wherein the average weight of said plurality of units is at least about 2000 kg.

5. A system according to claim 1, wherein said pH is less than about 11.

6. A system according to claim 1, wherein said pH is between about 9 to 10.5.

7. A system according to claim 1, wherein said pH of said concrete matrix is the pH of top surface of said unit.

8. A system according to claim 1, wherein the thickness of said surface is at least about 5 cm.

9. A system according to claim 1, wherein salinity of aquatic environment is between about 0 to 45 ppt.

10. A system according to claim 1, wherein said unit has a surface roughness having a roughness grade of at least 12.

11. A system according to claim 1, wherein said concrete matrix has a weight per volume of between about 1100 to about 2700 Kg/m3.

12. A system according to claim 1, wherein said concrete matrix has a weight per volume of between about 1100 to about 1800 Kg/m3.

13. A system according to claim 1, wherein said concrete matrix comprises between 0 to about 90% of the Portland cement.

14. A system according to claim 1, wherein said concrete matrix has average compressive strength of between about 30 to 80 Mpa.

15. A system according to claim 1, wherein said concrete matrix is capable of promoting the marine fauna and flora.

16. (canceled)

17. A method of scour protecting an aquatic infrastructure comprising providing a system comprising a plurality of units, wherein each unit comprises a concrete matrix having a pH of less than 12; and wherein each unit can interlock with at least one other unit of said plurality of units.
